(19) United States
(12) Patent Application Publication
(10) Pub. No.: US 2018/0359464 A1
(43) Pub. Date: Dec. 13, 2018

(54) Audio-Visual Signal Generator and Receiver for Signal Testing

(71) Applicant: Kevin K. Choi, Closter, NJ (US)

(72) Inventor: Kevin K. Choi, Closter, NJ (US)

(21) Appl. No.: 16/005,789

(22) Filed: Jun. 12, 2018

Related U.S. Application Data
(60) Provisional application No. 62/518,603, filed on Jun. 13, 2017.

(51) Int. Cl. H04N 17/00; H04R 29/00

(52) U.S. Cl. CPC H04N 17/00; G06F 3/0485; H04R 29/008

(57) ABSTRACT

The present disclosure refers to an apparatus and method for generating audio and visual signals and for receiving audio and visual signals for the purpose of testing the function and quality of devices and acoustics in an environment.

### TECHNICAL FIELD

The present disclosure relates to public-address systems; manually-operated control in untuned amplifiers; Visual indication of stereophonic sound images, management of an audio stream, e.g. setting of volume, audio stream path; and processing a detected response signal, e.g. electronic circuits specially adapted therefor using auto-correlation techniques or cross-correlation techniques. More specifically the present disclosure relates to audio/visual testing equipment that generates and receives signals for testing sound and video quality.

### BACKGROUND

Auditoriums, concert halls, performance spaces, conference rooms and other venues use sound-reproduction systems involving local and remote microphones, loudspeakers and video screens. Equipment that generates and receives signals for testing audio and video input and output includes sensors, antennas, microphones, signal processors, tone generators graphic equalizers and other acoustic-characteristic adjustment devices and methods. Specific audio characteristics are set by signal measurement, filtering, correction and reproduction. These adjustments can be displayed graphically in graphic-equalizer devices.

A performance environment is any room housing audio and visual signals.

Pink noise is a signal or process with a frequency spectrum such that the power spectral density is inversely proportional to the frequency of the signal. In pink noise, each octave carries an equal amount of noise energy.

### SUMMARY

A method, system and apparatus for testing the acoustics and visual equipment in a performance environment. The apparatus is an audio-visual signal generator and receiver for signal testing, configured with a number of audio and video inputs and outputs. Video inputs and outputs allow various monitors and systems to be tested and compared. An audio mixer allows control of pink noise for testing overall room-audio conditions. The apparatus includes an FM tuner for generating radio signals. A Bluetooth receiver allows for the use of a smartphone to be used to generate music of voice test sounds and signals. USB and SD card slots allow the user to play music or other sounds appropriate for the specific environment. Oscillating audio allows one to triangulate or tune specific microphones for specific environments.

The apparatus is a collection of sensors, audio and visual inputs and outputs with display screens, and digital or analog displays of signals generated or received. A rechargeable battery is housed in the apparatus.

The apparatus is mounted on a tripod at the height of an average human so as to test voice-simulated sound output. Video monitors with touch-panel controls show the status or signal types and the resolution and refresh rates of video-input signals.

Internal controls evaluate HDMI or other video signals and display the results on the monitors. Visual color bars show video patterns and resolutions for tuning and color-correcting of video inputs.

Video inputs and outputs allow various monitors and systems to be tested and compared. Manual controls allow scrolling through pattern, signal type and output selections. Disk-storage slots accept SD and other information-storage cards.

An audio mixer monitors and controls audio input and output. In some embodiments, audio outputs send signals to microphones being tested while the audio inputs receive the sent signals. Function and quality of signals are controlled by sending and receiving audio signals and measuring input and output. To play music or voice recordings, inputs are provided for memory cards.

Switches control signal generators for oscillating sound, white noise, pink noise, PGM, XLR and MIDI. Standard controls 145 include navigation 143 and volume 141 knobs for switching through and controlling various noise signals.

A speaker outputs signals and sounds generated by the apparatus. Audio outputs connect with common audio output devices. Data is output via USB, coaxial, HDMI or other output.

Other objects and features will become apparent from the following detailed description considered together with the accompanying drawings. Drawings are meant to illustrate rather than limit the embodiments.

### BRIEF DESCRIPTION OF THE DRAWINGS

To assist those of skill in the art in making and using the disclosed invention and associated methods, reference is made to the accompanying figures, wherein: Example figure descriptions follow:

FIG. 1 is a front view of the apparatus;

FIG. 2 is front view of the embodiment of FIG. 1 with the case opened displaying the audio and visual controls;

FIG. 3 is a detail view of FIG. 2;

FIG. 4 is an additional detail view of FIG. 2;

FIG. 5 is a right side view of the apparatus of FIG. 1;

FIG. 6 is a rear view of the embodiment of FIG. 1;

FIG. 7 is a left side view of the apparatus of FIG. 1;

FIG. 8 is a left side, bottom view of the apparatus of FIG. 1

FIG. 9 is a front view of an iteration of the embodiment in its closed position;

FIG. 10 is a detail view of the iteration of the embodiment of FIG. 9;

FIG. 11 is a front view of the iteration of the embodiment of FIG. 9;

FIG. 12 is a right-side view of the iteration of the embodiment of FIG. 9;

FIG. 13 is a back view of the iteration of the embodiment of FIG. 9;

FIG. 14 is a left-side view of the iteration of the embodiment of FIG. 9;

### DESCRIPTION

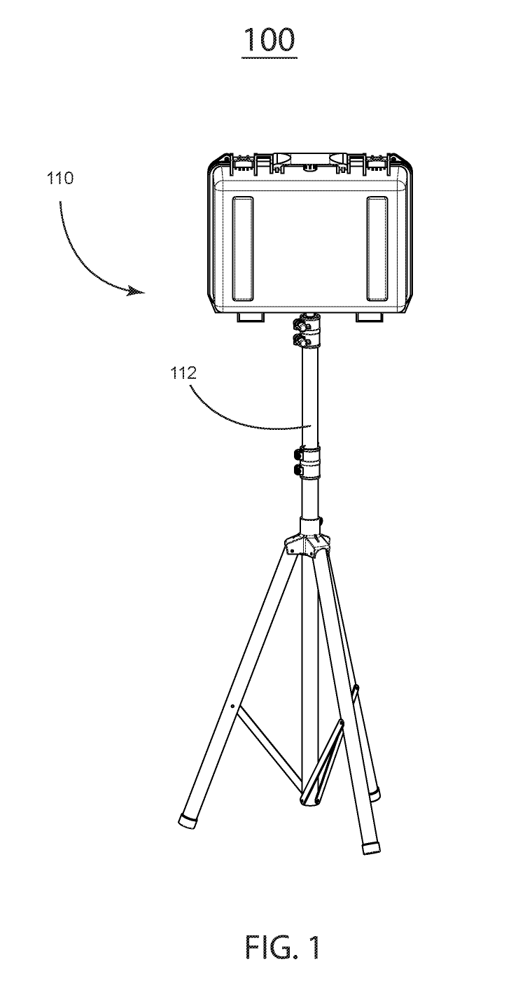

In FIG. 1 a perspective view of the present embodiment is illustrated. The apparatus is a collection of sensors; audio and visual inputs and outputs with display screens; and digital or analog displays of signals generated or received. A tripod 112 supports the apparatus 110 at a height of an average person's head so as to test voice-simulated sound output.

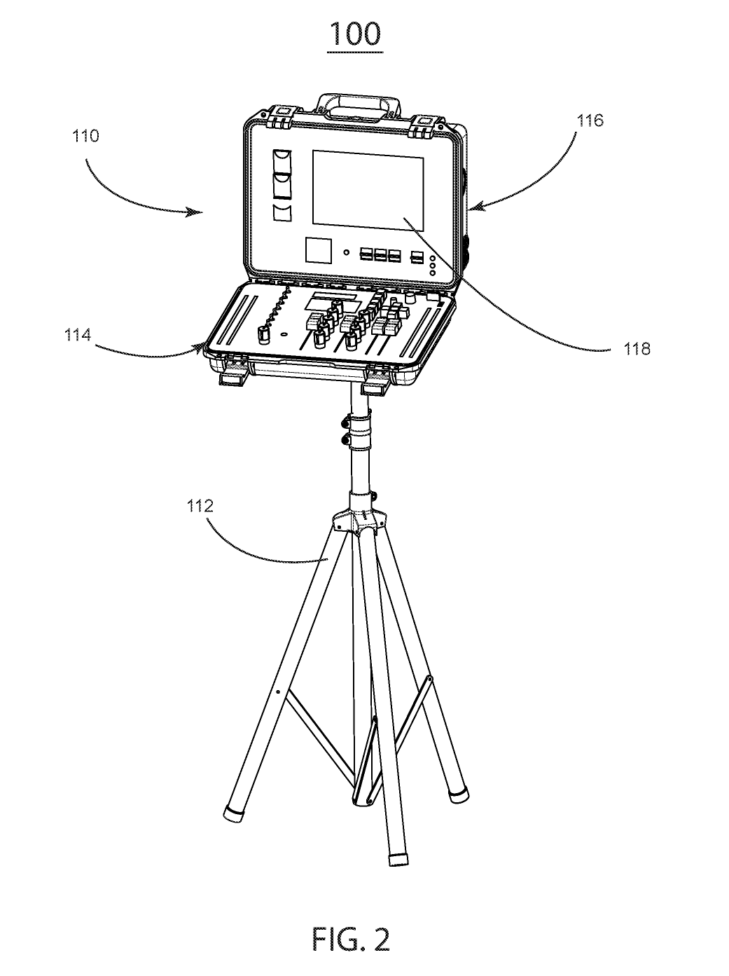

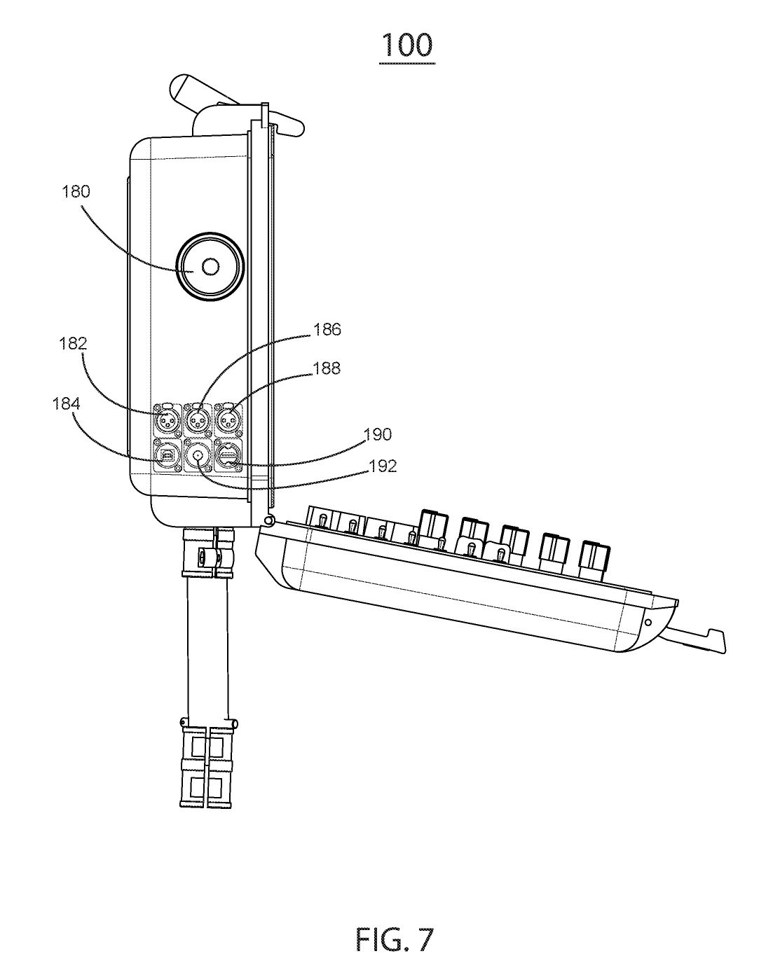

In FIG. 2 the apparatus is shown with its case open and mounted on a tripod 112. The top portion 116 is configured with video monitoring equipment and the lower portion 114 is configured with audio monitoring and controlling equipment. In the upper portion 116 a high-resolution display monitor 118 has a touch-panel control. The display monitor shows the status or signal type and the resolution and refresh rates of video-input signals. Video-signal inputs are plugged into receptacles (FIG. 7). Internal controls evaluate HDMI or other video signals and display results on the monitor 118 (FIG. 2).

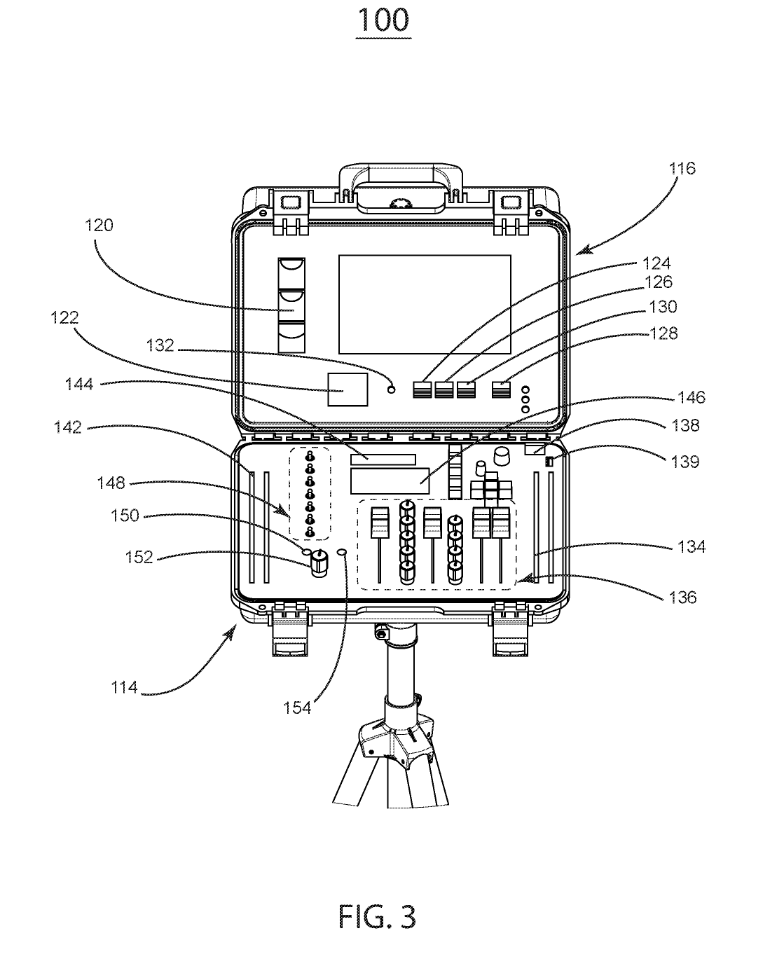

In FIG. 3, in the top portion 116, disk-storage pockets 120 store SD or other data-storage disks 138. A status light 132 illumines when the power is switched on. Paddle switches 124, 126, 128, 130 allow for scrolling through pattern, signal type and output selections. One skilled in the art understands the type of buttons illustrated.

In the lower section 114, data-storage inputs, preferable SD-card inputs 138 and USB 139 inputs, accept memory cards from which to play music or voice recordings. A color bar 122 is a small video display of patterns and resolutions for tuning and color-correcting video inputs. Components within the dashed-line square 136 comprise an audio mixer. One skilled in the art is familiar with common audio mixers. Signal input is measured and displayed in a lighted, status-level indicator bar 134 and signal output is measured by a similar bar 142. Function and quality of signals are controlled by sending and receiving audio signals and measuring input and output. A set of switches 148 controls audio signals of specific signal wavelengths. One skilled in the art understands the generation and measurement of signals controlled by switches 148. Other features include a headphone jack 150, volume knob 152, and unbalance input 154. Digital monitor screens 144, 146 and 148 show generated and received signals.

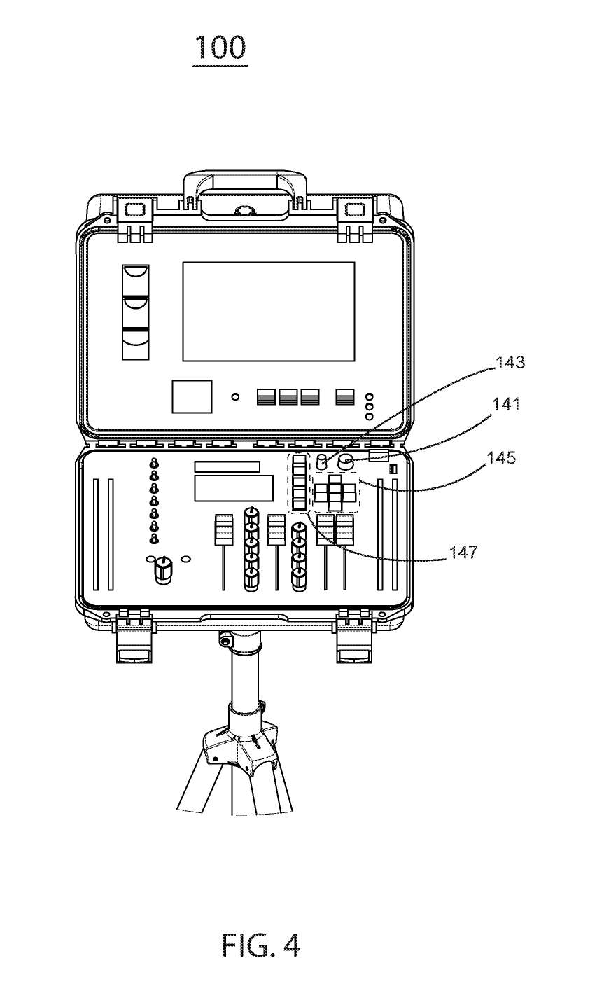

Referring to FIG. 4, additional features in the audio-control section include a series of push-button switches 147 for signal generators that generate oscillating sound, white noise, pink noise, PGM, XLR and MIDI. Standard controls 145 include navigation 143 and volume 141 knobs for switching through and controlling various noise signals. One skilled in the art understands how to use the various common controls.

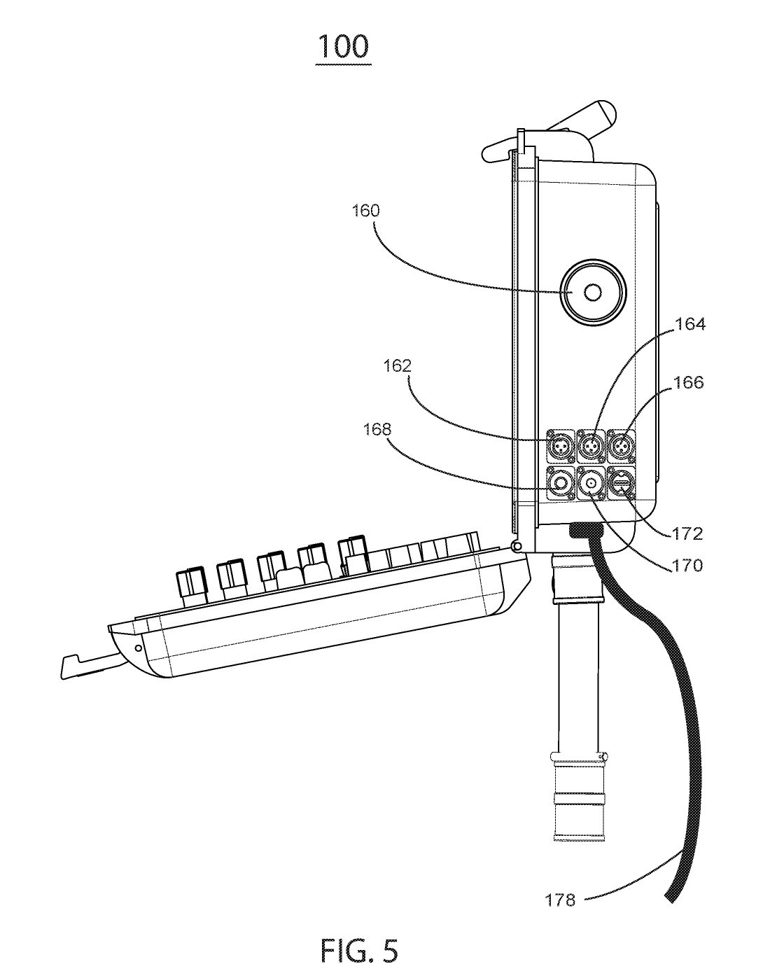

FIG. 5 illustrates the right side of the apparatus. A speaker 160 outputs signals and sounds generated by the apparatus. Left and right audio output 162 and 164 connect with common audio-output devices. In some embodiments, audio outputs send signals to microphones being tested while the audio inputs receive the sent signals. Output 166 is for producing an audio reference tone such as those used in a broadcasting system. Other outputs include HDMI video output 172 and HD-SDI output 170. A main power switch is shown in 168. Power is supplied by a cord 178.

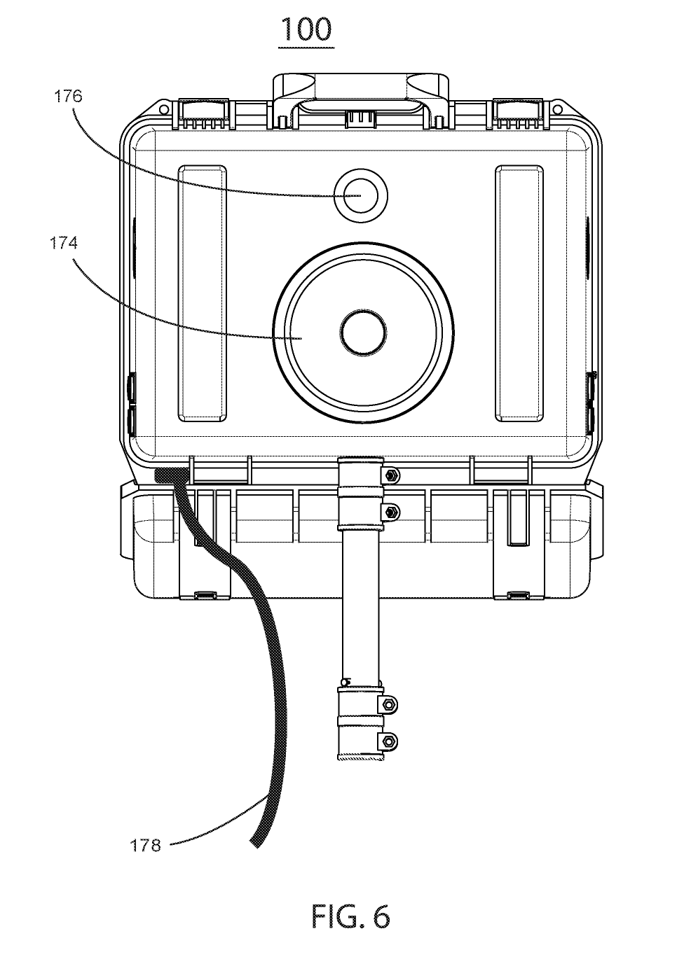

The rear of the apparatus is illustrated in FIG. 6. Full-range speakers 174 and 176 generate high-quality voice or music audio signals. A power supply cord is shown at 178.

FIG. 7 shows a set of inputs on the left side of the apparatus. A microphone input 182 receives microphone cords. Left and right audio signal inputs are labeled 186 and 188 respectively. A USB connection 184 allows for video or audio data input and output. A coaxial cable input 192 is for video-signal output. Input 190 is for HDMI signals. Speakers 180, 192 provide for additional audio-signal generation. In some embodiments, audio outputs send signals to microphones being tested while the audio inputs receive the sent signals.

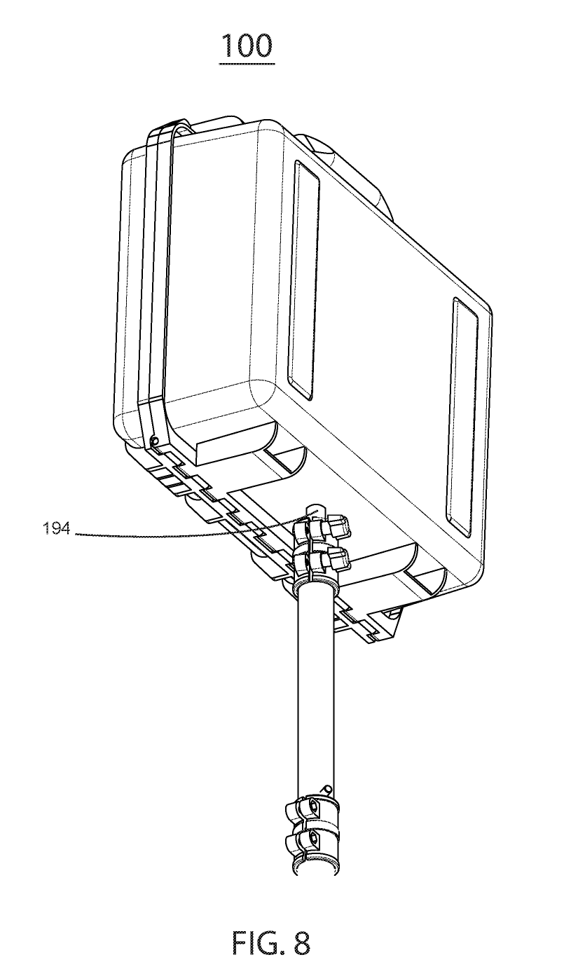

FIG. 8 shows a tripod-mounting point 194.

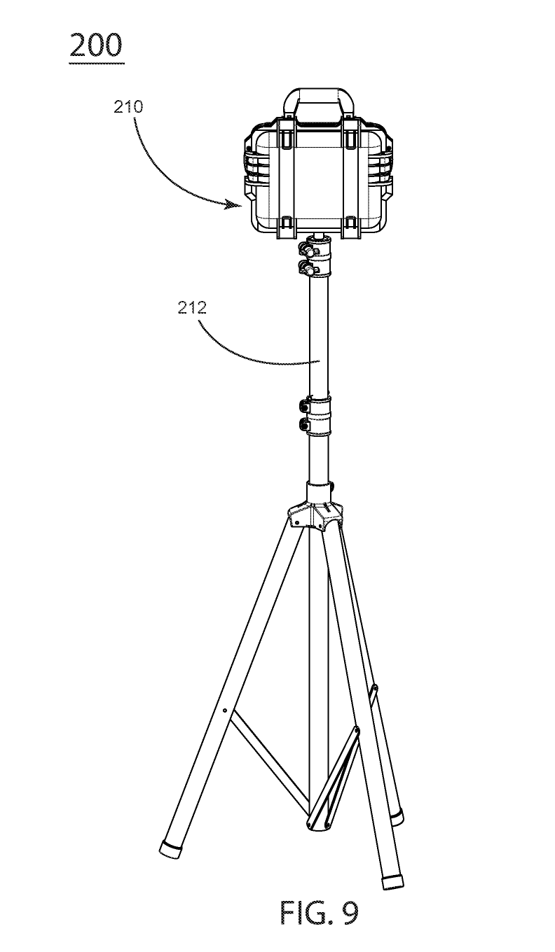

Another iteration of the embodiment 200 is illustrated in FIG. 9 through FIG. 14. In this iteration an apparatus monitors and controls audio signals without controls for video input or output. FIG. 9 illustrates the top of the apparatus enclosure.

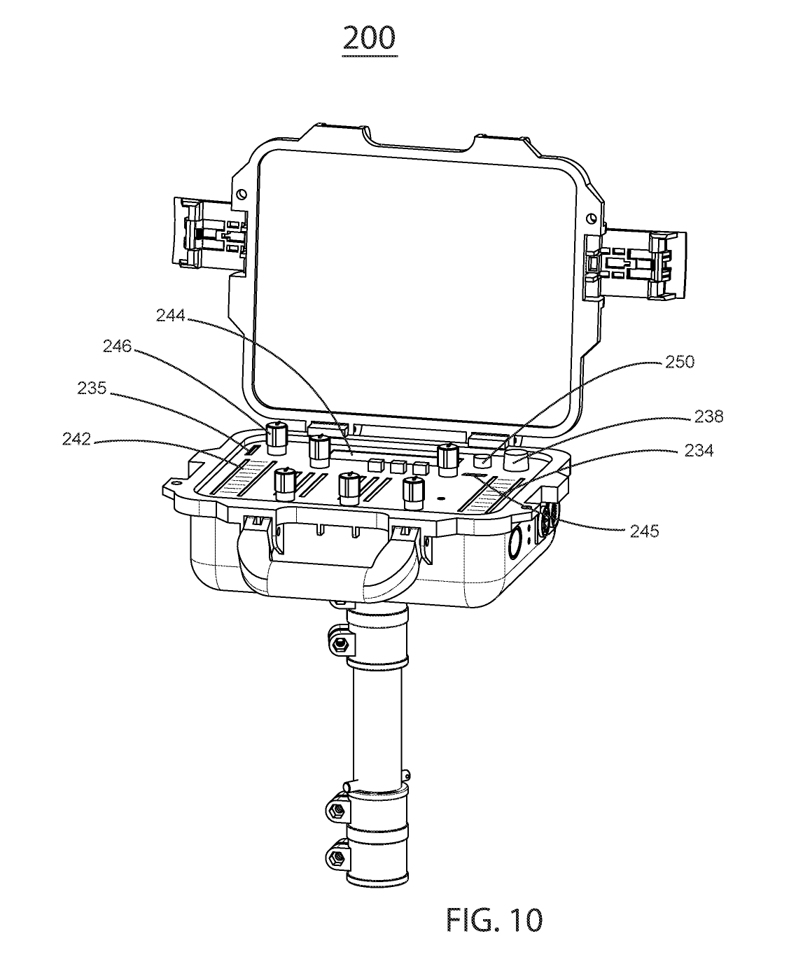

In FIG. 10, audio and other controls are housed in the lower portion of the enclosure. A screen 244 displays the type of audio signal being generated. Power and volume are controlled by knurled knobs 246. A USB port is shown at 235. Audio-signal output is depicted in the lighted, status-level indicator bar 242 and audio signal input is shown by a similar indicator 234. Battery power is indicated in the status-level indicator bar 245. A set of controls common to audio mixers occupies the center of the enclosure 236. One skilled in the art is familiar with common mixer controls. Selector knobs 250 and 238 allow the user to choose commands shown in display 244.

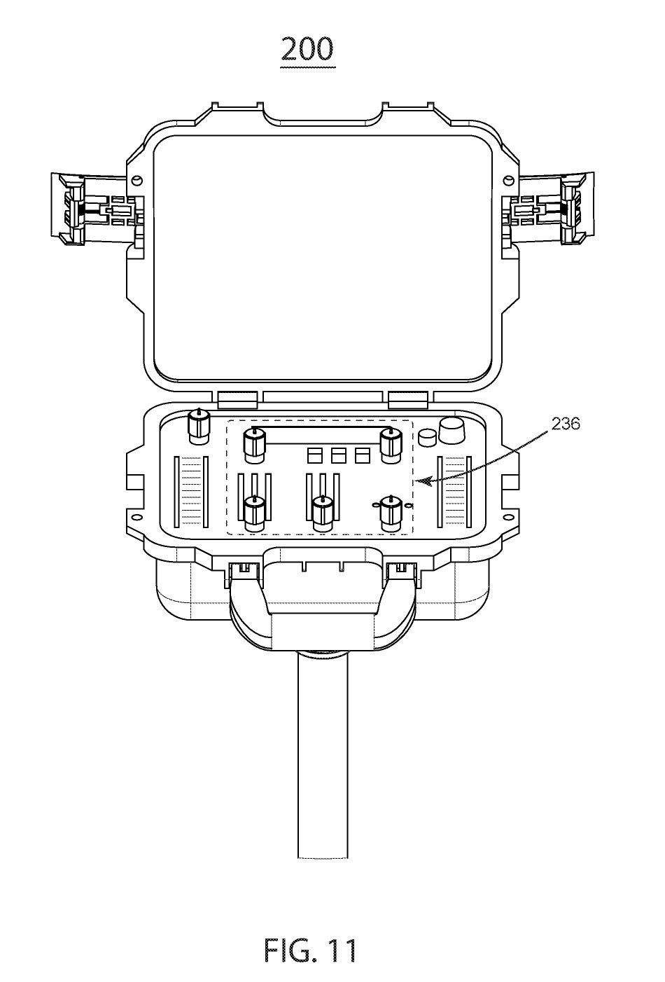

FIG. 11 shows the audio-mixer area 236 within the dashed lines.

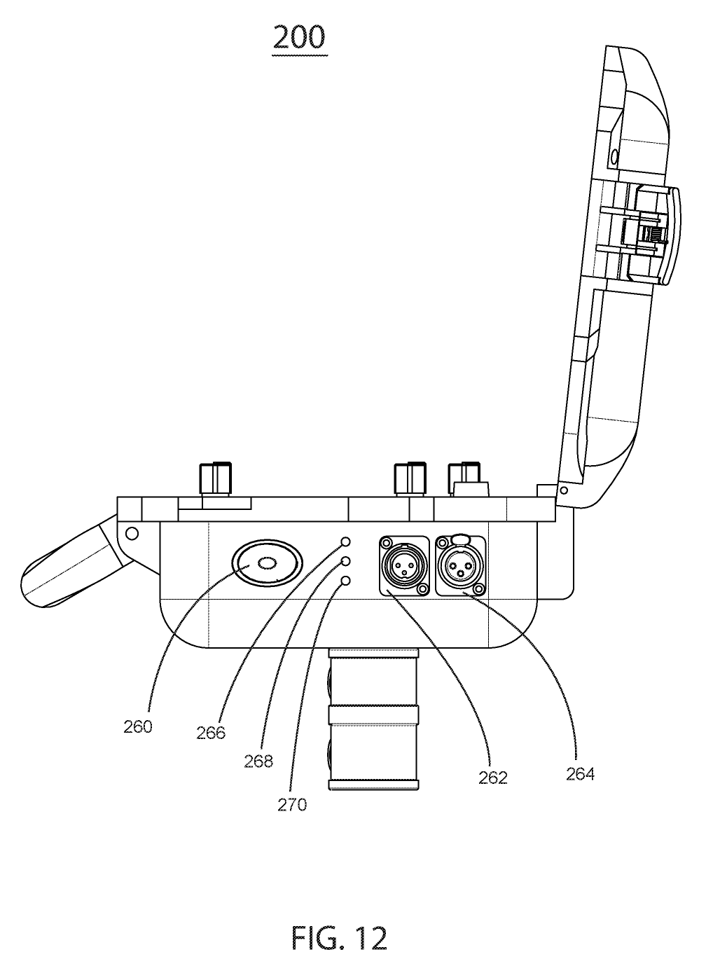

In FIG. 12 a series of outputs includes a speaker 260, an output for an audio tone 266, and TT-audio patch plugs for output left 268 and output right 270. A main output left channel 262 and a main output right channel 264 are for audio output to speakers or monitors.

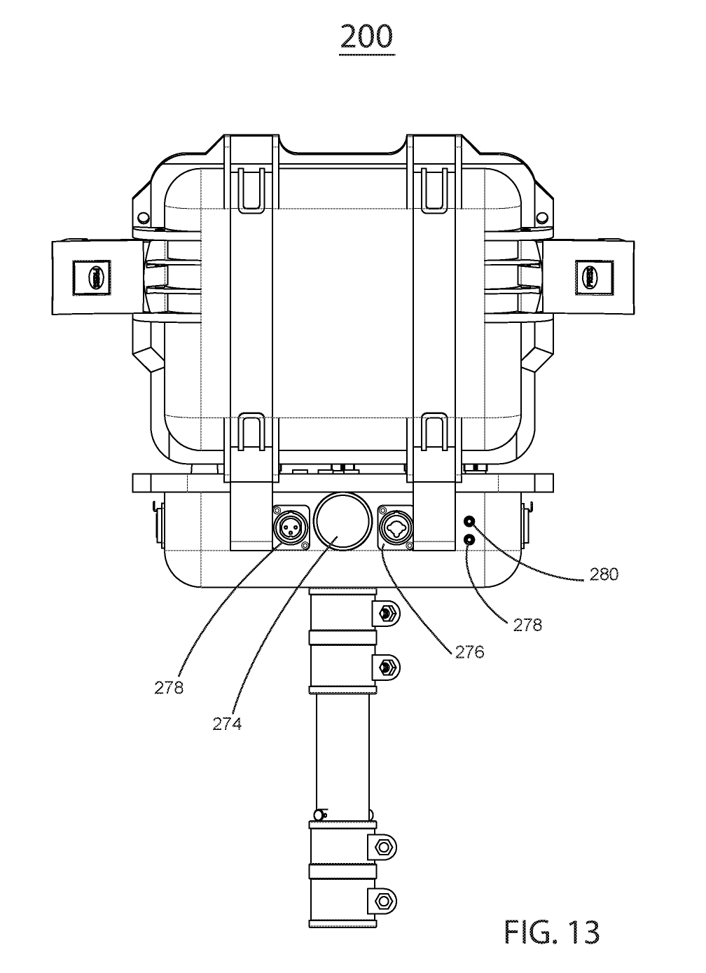

In FIG. 13, the rear of the apparatus has a speaker 274, a tone output 278, a microphone line output 276 and left and right RCA jacks 280 and 278.

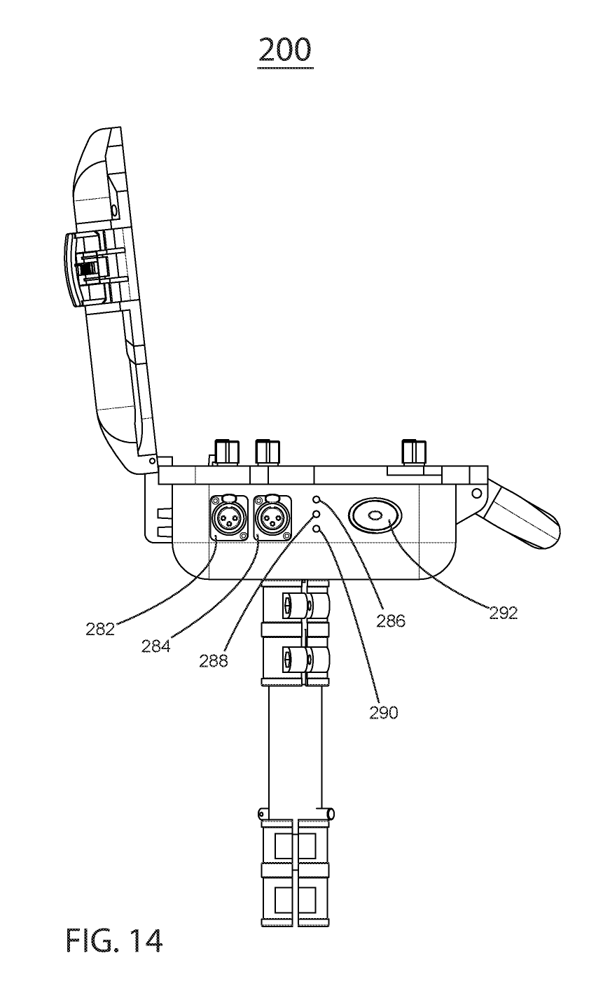

In FIG. 14, the right side of the unit is configured with a speaker 292 and left and right audio inputs 282 and 284. A series of TT-audio patch cord inputs include a microphone input 286, a left input 288 and a right input 290.

1. An apparatus for testing audio and video input and output comprising:
a set of video monitoring equipment engaged with a first half of a case; and
a set of audio monitoring equipment engaged with a second half of a case; and
the set of video monitoring equipment further comprising:
a monitor for displaying signal type, resolution, refresh rates of video input signals; and
at least two video input receptacles engaged with the first half of said case; and
at least two video output receptacles engaged with the first half of said case; and
a control for scrolling through video pattern selection options; and
a control for scrolling through video signal type selection options; and
a control for scrolling through video output selection options; and
a color bar display; and
the set of audio monitoring equipment further comprising:
an audio mixer; and
at least one audio output receptacle; and
at least one audio input receptacle; and
at least two switches for generating audio wavelengths between 1 Hz and 50 KHz; and
a digital monitoring screen for displaying the level of signals generated; and
a digital monitoring screen for displaying the level of signal received; wherein audio and video signals generated are measured and displayed; and audio and video signals received are measured and displayed.

2. The apparatus of claim one wherein the monitor is a touch panel control.

3. The apparatus of claim one wherein the first half of the case further comprises storage area for at least one information storage device.

4. The apparatus of claim one further comprising at least three audio output

5. The apparatus of claim one wherein the at least two switches for generating audio wavelengths, further comprises:
a first switch for initiating a wavelength generator for generating a wavelength between 1 Hz and 50 KHz variable output level; and
a second switch for initiating a wavelength generator for generating a wavelength between 1 hz and 50 KHz fixed 0 dBu output level; and
a third switch for initiating a wavelength generator for generating a wavelength between 1 hz and 50 KHz; fixed +4 dBu output level and a fourth switch for initiating a wavelength generator for generating a white noise; and
a fifth switch for initiating a wavelength generator for generating a pink noise; and

6. An apparatus for testing audio input and output comprising:
a case having a first half and a second half; and
a set of audio controls housed in the first half of the case; and
the set of audio controls further comprising:
an audio signal generator; and
a screen for displaying the type of audio signal being generated; and
a volume control; and
a visual display depicting audio signal output volume; and
a visual display depicting audio signal input volume; and
an audio mixer; and
at least one speaker; and
at least one receptacle for an electric cord for carrying an output signal to an external speaker; and
at least one receptacle for an electric cord for carrying an audio input; wherein sounds, tones and signals may be generated and received, and may be measured and said measurements depicted by the audio visual displays.

7. The apparatus of claim five wherein audio signals generated by the audio signal generator are depicted by a lighted, status-level indicator bar.

8. The apparatus of claim five wherein audio signals received by the audio signal input receptacle are depicted by a lighted, status-level indicator bar.

9. The at least one receptacle for an electronic cord for carrying an audio input is an ⅛-inch plug receptacle.

10. The at least one receptacle for an electronic cord for carrying an audio output is an ⅛-inch plug receptacle.

11. The at least one receptacle for an electronic cord for carrying an audio input is an RCA receptacle.
